(19) United States
(12) Patent Application Publication
(10) Pub. No.: US 2025/0322160 A1
(43) Pub. Date: Oct. 16, 2025

(54) Systems and Methods for Machine Learning Using Hyperformers

(71) Applicant: Superintelligence Computing Systems SICSAI AB, Stockholm (SE)

(72) Inventors: Per-Eric Olsson, Helsingborg (SE); Karim Nouira, Stockholm (SE)

(21) Appl. No.: 18/925,925

(22) Filed: Oct. 24, 2024

Related U.S. Application Data
(60) Provisional application No. 63/633,018, filed on Apr. 11, 2024.

(51) Int. Cl. G06F 40/284; G06N 3/0455; G06N 3/0499

(52) U.S. Cl. CPC G06F 40/284; G06N 3/0455; G06N 3/0499

(57) ABSTRACT

A plurality of tokens in an input sequence is rearranged in accordance with a number of the tokens in the input sequence, a number of subvectors per token, and a number of entries per subvector: an embedding vector for each token in the input sequence is generated and is divided into a plurality of subvectors to produce a hyperspace embedding. A positional encoding is added to the hyperspace embedding. The positionally encoded hyperspace embedding is processed in a decoder subnetwork: the positionally encoded hyperspace embedding is unfolded into a QKV representation, with a single query Q being obtained from the plurality of subvectors; the single query Q is applied to each subvector of the plurality of subvectors; and an attention function is calculated for each subvector. A plurality of output tokens is selected based at least in part on a result of the processing.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED APPLICATION

This application claims the benefit of U.S. Provisional Patent Application No. 63/633,018, filed on 11 Apr. 2024, which is incorporated by reference in its entirety.

### TECHNICAL FIELD

This disclosure relates to machine learning, and more specifically to transformer methods and systems.

### BACKGROUND

A transformer is a type of deep-learning model that uses self-attention mechanisms to process and generate sequential data, such as natural language text. Its architecture allows it to model the context of words in sentences, making it highly effective for tasks like translation, text summarization, and content generation. Unlike traditional models that process data sequentially, transformers can handle inputs in parallel, significantly improving efficiency and performance in handling large datasets.

Deep learning models developed before the transformer include, for example, recurrent neural networks (RNNs) and long short-term memory (LSTM). These models use a deep network with many layers of neurons with parameters, which cause back-propagation training to take a long time. The transformer has fewer layers (i.e., is not as deep) and can therefore be trained faster and with better results compared to RNNs and LSTMs. However, the transformer still layers (i.e., contains a stack of) N copies of a subnetwork (e.g., a sequence of encoder/decoder subnetworks), increasing the depth N times.

Since GPU processing scales with the number of parameters, improvements that further reduce the number of parameters while still achieving approximately the same evaluation loss and training time can be used to reduce resource demand and energy consumption.

### SUMMARY

Systems and methods are described for a modified transformer that uses hyperspace embeddings. This modified transformer is called a hyperformer. A hyperspace embedding is an extension of a normal embedding vector into a number of hyperspace dimensions, each with its own subvector. The hyperspace embedding and the subvectors can be said to describe parallel hypotheses; during training, they crystallize and move toward orthogonality. This leads to better information preservation in a deep-learning model.

The hyperformer may train the hyperspace embedding toward orthogonality between the subvectors in selected locations in the hyperformer. Such locations may include when entering and exiting a multi-head self-attention block and during a final linear layer. Training toward orthogonality may be performed using a low-rank hyperspace (LoRH) function, as described herein. A LoRH function provides a parameter-efficient linear projection, which allows for a compact and efficient model.

Particular embodiments can be implemented to realize a decoder-only hyperformer or an encoder/decoder hyperformer.

### Examples of Implementations

In some embodiments, a machine-learning method includes receiving an input sequence including a plurality of tokens and rearranging the plurality of tokens in accordance with a number of the tokens in the input sequence, a number of subvectors per token, and a number of entries per subvector. Rearranging the plurality of tokens includes generating an embedding vector for each token in the input sequence and dividing the embedding vector into a plurality of subvectors to produce a hyperspace embedding. The method also includes adding a positional encoding to the hyperspace embedding to produce a positionally encoded hyperspace embedding, and processing the positionally encoded hyperspace embedding in a decoder subnetwork. In this processing, the positionally encoded hyperspace embedding is unfolded into a query, key, and value (QKV) representation, with a single query Q being obtained from the plurality of subvectors; the single query Q is applied to each subvector of the plurality of subvectors; and, with the single query Q applied to each subvector, an attention function is calculated for each subvector. The method further includes selecting a plurality of output tokens based at least in part on a result of the processing.

The attention function may be a multi-head attention function that includes a plurality of heads. Calculating the attention function may include dividing the entries in each subvector into a number of subvector portions equal to a number of heads in the plurality of heads; providing each subvector portion to a respective head of the plurality of heads; in each head of the plurality of heads, calculating the attention function for the respective subvector portion provided to the head to produce a respective result; and combining the respective results from the plurality of heads.

In the decoder subnetwork, before calculating the attention function, a linear projection may be used to project two QKV factors that provide a full QKV projection when multiplied together. The full QKV projection is used in calculating the attention function. After calculating the attention function and combining the respective results, the linear projection may be used in the decoder subnetwork to project two factors for the combined respective results from the plurality of heads for the plurality of subvectors. The two factors provide an attention output for the positionally encoded hyperspace embedding when multiplied together.

Skip-forward addition of the positionally encoded hyperspace embedding with the attention output for the positionally encoded hyperspace embedding may be performed, to produce a first sum. The first sum may be normalized.

The normalized first sum may be provided to a feed-forward network. Skip-forward addition of the normalized first sum with an output of the feed-forward network may be performed, to produce a second sum. The second sum may be normalized. The normalized second sum is a decoder-subnetwork output.

The decoder subnetwork may be a first decoder subnetwork in a series of decoder subnetworks. The method may further include repeating the processing of the positionally encoded hyperspace embedding in each decoder subnetwork after the first decoder subnetwork in the series, using a respective input of each decoder subnetwork in place of the positionally encoded hyperspace embedding used in the first decoder subnetwork. The respective input of each decoder subnetwork after the first decoder subnetwork in the series may be the decoder-subnetwork output of the previous decoder subnetwork in the series.

Selecting the plurality of output tokens may include providing the decoder-subnetwork output of a final decoder subnetwork in the series of decoder subnetworks to a linear layer. In the linear layer, the linear projection may be used to project two factors that, when multiplied together, provide an output for the linear layer.

Selecting the plurality of output tokens may further include calculating a softmax function using the output for the linear layer, to produce output-token probabilities, and selecting an output token of the plurality of output tokens based on the output-token probabilities.

The method may further include calculating a loss function. The loss function is calculated, for example, based at least in part on a difference between the selected output token and an expected output token. In another example, the loss function is calculated based at least in part on a difference between the output for the linear layer and an expected output for the linear layer.

In some embodiments, a computer system includes one or more processors and memory storing one or more programs configured for execution by the one or more processors. The one or more programs include instructions for performing this method. In some embodiments, a non-transitory computer-readable storage medium stores one or more programs for execution by one or more processors. The one or more programs include instructions for performing this method.

### BRIEF DESCRIPTION OF THE DRAWINGS

FIG. 1 shows a machine-learning system with a hyperformer in accordance with some embodiments.

FIG. 2 shows a flowchart of a masked multi-head attention block within a hyperformer in accordance with some embodiments.

FIG. 3 shows a flowchart of a final linear block within a hyperformer in accordance with some embodiments.

FIG. 4 shows a flowchart of a hyperformer method in accordance with some embodiments.

FIG. 5 shows a flowchart of a low-rank hyperspace (LoRH) function in accordance with some embodiments.

FIG. 6 shows a flowchart of a machine-learning method performed by a hyperformer in accordance with some embodiments.

FIG. 7 shows a flowchart of a method of processing a positionally encoded hyperspace embedding in a decoder subnetwork of a hyperformer in accordance with some embodiments.

FIG. 8 is a block diagram of a computer system that implements a hyperformer, in accordance with some embodiments.

Like reference numbers and designations in the drawings indicate like elements throughout.

### DETAILED DESCRIPTION

Reference will now be made in detail to various embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Hyperspace embeddings can encode information in a compact way while still being computationally feasible. A hyperspace embedding is an extension (i.e., division) of a transformer's embedding vector into a number of hyperspace dimensions, each with its own subvector. A hyperspace embedding thus includes a plurality of subvectors.

Hyperspace embeddings fit well with attention-based transformers such that the attention mechanism will have a rich and learnable set of filters, not just on one feature vector, but on the combined hypotheses or concepts corresponding to the plurality of subvectors. Each subvector in the plurality of subvectors corresponds to a respective hypothesis or concept. This use of subvectors makes each transformer block more powerful. The hyperspace embeddings can be used to generate better interpretability and expressiveness, extending to introspection and knowledge graphs/clustering of conceptual representations. The improved expressiveness reduces the number of parameters while maintaining the same evaluation loss (or approximately the same evaluation loss) and using less energy during training.

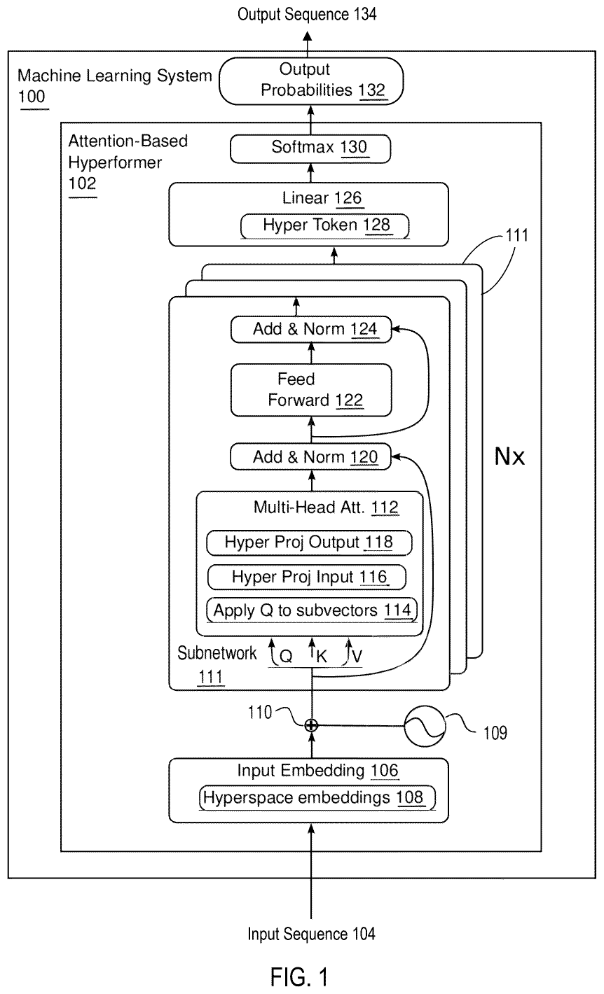

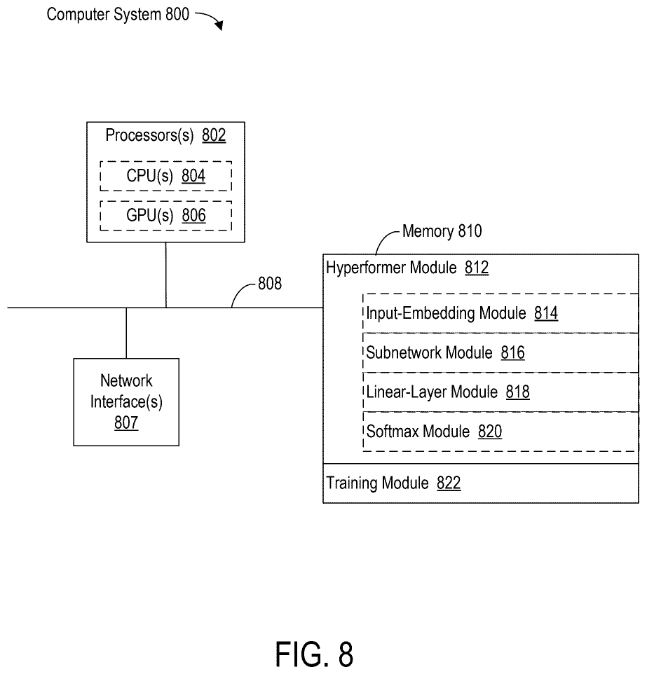

FIG. 1 shows a machine-learning system 100 with an attention-based hyperformer 102 in accordance with some embodiments. The hyperformer 102 is a decoder-only hyperformer. The machine-learning system 100 may be a stand-alone machine-learning system or may be part of a larger machine-learning system (e.g., an encoder-decoder hyperformer). The machine-learning system 100 is a system implemented as one or more computer programs on one or more computer systems (e.g., computer system(s) 800, FIG. 8) in one or more locations. The computer program(s) implement an attention-based hyperformer 102. The machine-learning system 100 receives an input sequence 104 and processes the input sequence 104 to transduce the input sequence 104 into output probabilities 132 using layers 106 through 130. The input sequence 104 is a sequence of input tokens. The output probabilities 132 are used to form a sequence of output tokens.

The output probabilities are used to select the next token for the output sequence. Examples of input and/or output tokens include tokens for words for a large language model (LLM) and visual input tokens (e.g., from a camera for a pick-and-place robot, where the output tokens are the instructions to the robot arm for picking). Other examples of applications (e.g., involving visual input tokens) include controlling an industrial robot assembly, a general-purpose robot, or any other robot application. Other examples of input and/or output tokens include tokens for any modality or sensor, such as tactile sensors, LIDAR sensors, sound sensors (e.g., microphones), and more.

In other embodiments the hyperformer is used to train a foundation model that in turn integrates with other technologies (e.g., robots, databases, calculators, sensors, narrow AI, or other tools and/or data sources). The hyperformer can be used in applications, such as general-purpose mobile robots (e.g. humanoid robots), supply-chain manufacturing, inspection, surveillance, warehouse automation, and navigation in unknown environments or for self-driving vehicles. The hyperformer can be used in disembodied applications, such as chat-bots, search, support, analytics, administration, gaming, education, healthcare, finance, and system control.

The attention-based hyperformer 102 includes an embedding layer 106, an addition layer 110, N copies of a decoder subnetwork 111 (N being an integer greater than or equal to one), a final linear output layer 126, and a softmax function 130. The N copies of the subnetwork 111 are arranged in series and are shown as being stacked on top of each other in FIG. 1. The hyperformer 102 is configured to receive the input sequence 104 and, in an embedding layer 106, to generate a respective embedding vector for each of the input tokens in the input sequence 104.

In some embodiments, to balance training performance versus convergence speed, the actual training is performed on batches. The training is thus performed on a set of numbers arranged as matrices with dimensions B, T, C, and H, where B stands for the number of input sequences 104 in a batch, T the number of tokens in an input sequence 104, H the number of hyperspace dimensions, and C the size of the subvectors. The input tokens, and the numbers within them, are thus rearranged in accordance with these dimensions. A hyperspace token embedding, referred to as a hyperspace embedding for short, is generated in a hyperspace embeddings layer 108 in the embedding layer 106. For example, the hyperspace embedding is generated with:

def calc_tok_emb(self, idx):
# forward the GPT model itself
tok_emb = self.transformer.wte(idx)
tok_hyperspace = rearrange(tok_emb,
‘B T (H C) −> B T H C’,H=self.n_hyper)
# shape(b,t,n_hyper,n_embd)

(This code and all subsequent code are @2024 Superintelligence Computing Systems SICSAI AB)

At the addition layer 110, the embedding vectors, which include respective hyperspace embeddings, are added to a positional encoding 109. For example:

# Add positional encoding
hyperspace = tok_hyperspace + pos_hyperspace

Where the positional encoding pos_hyperspace may be calculated as:

def calc_pos_emb(self, device, B, T):
pos = torch.arange(0, T, dtype=torch.long, device=device).unsqueeze(0)
# shape (1, t)
pos_emb = self.transformer.wpe(pos)
pos_hyperspace = repeat(pos_emb, ‘1 T (H C) −>
B T H C’, B=B, H=self.n_hyper)
# shape (b, t, n_hyper, n_embd)
return pos_hyperspace

The initial subnetwork 111 (i.e., the first of the N copies of the subnetwork 111) receives its input from the addition layer 110. The input of each successive subnetwork 111 is received from the output of the previous subnetwork 111. Each output of a respective subnetwork 111 (except the final subnetwork 111) is fed as the input to the next subnetwork 111. The output of the final subnetwork 111 is provided to the final linear output layer 126. The output from the addition layer 110 (for the initial subnetwork 111) or from a previous subnetwork 111 (for subsequent subnetworks 111) enters each subnetwork 111, where the hyperspace embedding is unfolded into a transformer query, key, and value (QKV) representation. For example:

x = rearrange(x, ‘B T H C −> B T (H C)’)
# Unfold hyperspace embedding to full QKV
x = self.c_attn(x)

Each subnetwork 111 includes a masked multi-head attention layer 112, a first skip-forward addition 120, a feed-forward network 122, and a second skip-forward addition 124. The QKV representation is provided to the masked multi-head attention layer 112, which performs steps 114, 116, and 118. At step 114, the query Q in the QKV representation is applied to all of the subvectors in a hyperspace embedding (i.e., to all of the subvectors for an embedding vector):

q = repeat(x[:, :, −C:], ‘B T C −> B T H C’, H=H) # B, T, H, C
# Move the pointer x to KV. i.e. jump over Q.
x = x[:, :, :−C]

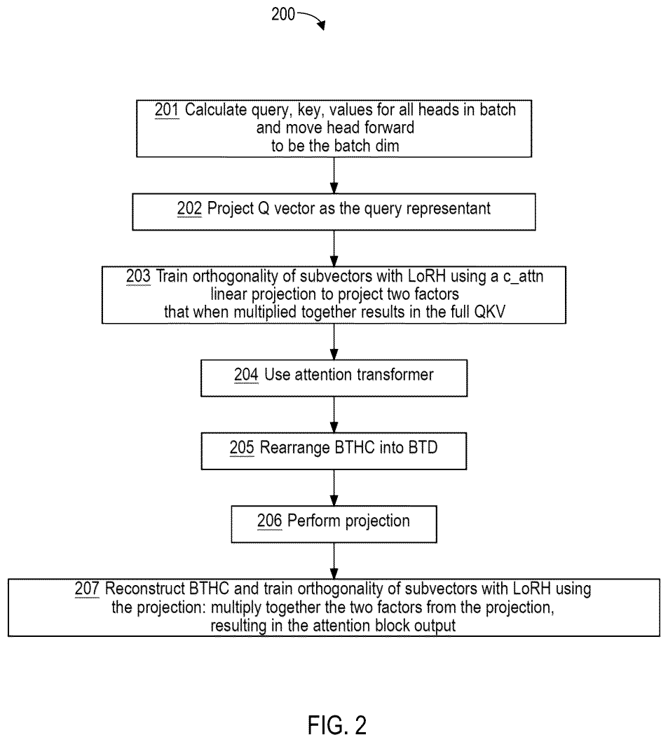

At step 116, a low-rank hyperspace (LoRH) function (as described below for step 203, FIG. 2) is applied to the hyperspace embeddings to train the subvectors toward orthogonality. The masked multi-head attention layer 112 then proceeds using a transformer attention calculation, after which step 118 follows. At step 118, the LoRH function is again applied to the hyperspace embeddings to train the subvectors toward orthogonality. The output from step 118 is the output of the masked multi-head attention layer 112.

At the first skip-forward addition 120, the input to the masked multi-head attention layer 112 is added to the output from the masked multi-head attention layer 112 and the sum is normalized. The normalized sum is provided to a feed-forward network 122 (i.e., a multi-layer perceptron), which performs two linear transformations with an application function in between. The activation function may be a Gaussian error linear unit (GELU), a rectified linear unit (ReLU), or some other activation function. The feed-forward network 122 is followed by the second skip-forward addition 124. At the second skip-forward addition 124, the input to the feed-forward network 122 is added to the output from the feed-forward network 122 and the sum is normalized. This completes a respective subnetwork 111 (e.g., the first subnetwork 111): the normalized sum from the second skip-forward addition 124 is the output of the subnetwork 111. The operations of the subnetwork 111 are repeated N times.

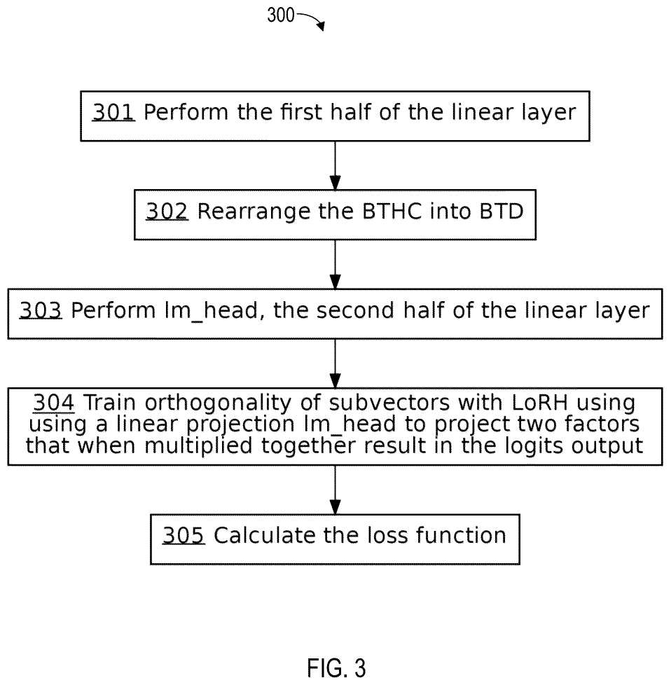

The output of the final decoder subnetwork 111 (i.e., of the last of the N decoder subnetworks 111) is fed into the final linear output linear layer 126. The final linear output layer 126 performs a hyperspace tokenization 128 that applies LoRH to train the subvectors toward orthogonality, as described below for FIG. 3.

The output of the final linear output layer 126 is provided to the softmax function 130, which provides output probabilities 132. The output probabilities 132 provided by the softmax function 130 are used to select the most probable output token. When training, the loss function can be calculated either from the output after the final linear output layer 126 or after the softmax function 130.

FIG. 2 shows a flowchart of a masked multi-head attention block 200 within a hyperformer in accordance with some embodiments. The masked multi-head attention block 200 is an example of the masked multi-head attention layer 112 in the attention-based hyperformer 102 of the machine-learning system 100 (FIG. 1). The masked multi-head attention block 200 includes steps 201 through 207.

In step 201, the query, keys, and values are calculated for all heads in the batch and the head is moved forward to be the batch dimension. Step 201 unfolds the hyperspace embedding into a QKV representation. This can be achieved with the following PyTorch code:

B, T, H, C = x.size( )
x = rearrange(x, ‘B T H C −> B T (H C)’)
# Unfold hyperspace embedding to full QKV
x = self.c_attn(x)

In step 202 the query Q is applied to the subvectors in the hyperspace embedding:

if self.att_query_as_vector:
q = repeat(x[:, :, −C:], ‘B T C −> B T H C’, H=H) # B, T, H, C
# Move the pointer x to KV. I.e. jump over Q.
x = x[:, :, :−C]
kqv = 2
else:
kqv = 3

In step 203 the subvectors are trained toward orthogonality using a linear projection c_attn to project two factors that when multiplied together result in the full QKV projection. This is the LoRH function (e.g., the LoRH function of step 116, FIG. 1).

```
# We have KQV let us factorize them.
x_10 = rearrange(
  x[..., : kqv * self.n_hyper * self.n_att_lorh],
    ‘B T (kqv Hn_att_lorh) −> B T kqv Hn_att_lorh’,
    n_att_lorh=self.n_att_lorh,
    kqv=kqv,
)
x_11 = rearrange(
    self.att_query_as_vector[
    ...,
    kqv
    * self.n_hyper
    * self.n_att_lorh : −C if self.att_query_as_vector_else
    self.att_query_as_vector.shape[−1],
  ],
  ‘B T (kqv n_att_lorh C) −> B T kqv n_att_lorh C’,
  n_att_lorh=self.n_att_lorh,
  kqv=kqv,
)
x = x_10 @ x_11
X = rearrange(x, ‘B T kqv H C −> B T H (kqv C)’)
```

In step 204 the attention transformer is used (e.g., the transformer attention calculation of the masked multi-head attention layer 112 (FIG. 1) is performed). For example:

```
  q, k, v = x.split(self.n_embd, dim=3)
  # nh = number of heads H = hyperspace T = tokens hs = remaining vector.
  # Important cut along H = number of hypserspace vectors.
  # H is often 6, C can be for example 48 or 64.
  k = rearrange(k, ‘B T H (nh hs) −> B nh H T hs’, nh=self.n_head)
  q = rearrange(q, ‘B T H (nh hs) −> B nh H T hs’, nh=self.n_head)
  v = rearrange(v, ‘B T H (nh hs) −> B nh H T hs’, nh=self.n_head)
  ########
  # Self-attend: (B, nh, H, T, hs) x (B, nh, H, hs, T) −> (B, nh, H, T, T)
  # We work on QK here.
  att = (q @ k.transpose(−2, −1)) * (1.0/ math.sqrt(k.size(−1)))
  # An extra colon in bias to accomodate for H.
  att = att.masked_fill(self.bias[:, :, :, :T, :T] == 0, float(‘−inf’))
  att = self.softmax(att, dim=−1)
  att = self.attn_dropout(att)
  ########
  y = att @ v # (B, nh, H, T, T) x (B, nh, H, T, hs) −> (B, nh, H, T, hs)
  # Y is now organized as: Batch numheads Hyperspace Tokencount remaining_vector
  y = y.transpose(1, 3).contiguous( ).view(B, T, H, C) # re-assemble all head outputs side by
side
```

In step 205, BTHC is rearranged into BTD. For example:

$$y = rearrange ( y , {}^{′} BTHC -> {BT ( HC )}^{′} )$$

In step 206, the projection is performed. A linear projection c_proj may be used to project two factors that when multiplied together will result in the output of the attention transformer. For example:

$$y = self . c\_proj ( y )$$

In step 207, BTHC is reconstructed and the subvectors are trained toward orthogonality during hyperspace output projection. For example, the two factors produced by the linear projection c_proj are multiplied together to result in the output of the attention transformer. This is the LoRH function (e.g., the LoRH function of step 118, FIG. 1).

# Hyperspace output projection
y_10 = rearrange(
y[..., : self.n_hyper * self.n_att_lorh],
‘B T (Hn_att_lorh) −> B T H n_att_lorh’,
n_att_lorh=self.n_att_lorh,
)
y_11 = rearrange(
y[..., self.n_hyper * self.n_att_lorh :],
‘B T (n_att_lorh C) −> B Tn_att_lorh C’,
n_att_lorh=self.n_att_lorh,
)
y= y_10 @ y_11

FIG. 3 shows a flowchart of a final linear block 300 within a hyperformer in accordance with some embodiments. The final linear block 300 is an example of the final linear output layer 126 in the attention-based hyperformer 102 of the machine-learning system 100 (FIG. 1). The final linear block 300 includes steps 301 through 305.

In step 301, a first half of the final linear output layer is performed. The first half is a linear normalization of the subvectors in the hyperspace. For example:

# The linear transformation includes both ln_f and lm_head.
x = self.transformer.ln_f(x)
x_embedding = x
logits = x

In step 302, the BTHC is rearranged into BTD. For example:

$$logits = rearrange ( x , {}^{′} BTHC -> {BT ( HC )}^{′} )$$

In step 303, a second half of the linear layer is performed. The second half is a linear projection. For example:

$$logits = self . lm\_head ( logits )$$

In step 304, hyperspace tokenization is performed to train the subvectors toward orthogonality with LoRH using the linear projection of step 303 (e.g., the linear projection “lm_head”). The two factors produced by the linear projection are multiplied together to result in the logits output. For example:

```
logits_10 = rearrange(
    logits[..., : self.n_hyper * self.n_out_vocab_lorh],
    ‘B T (Hn_out_vocab_lorh) −> B T H n_out_vocab_lorh’,
    n_out_vocab_lorh=self.n_out_vocab_lorh,
    )
    logits_11 = rearrange(
    logits[..., self.n_hyper * self.n_out_vocab_lorh :],
    ‘B T (n_out_vocab_lorh V) −> B T n_out_vocab_lorh V’,
    n_out_vocab_lorh=self.n_out_vocab_lorh,
    )
logits = logits_10 @ logits_11 # shape (b, t, n_hyper, V)
logits = rearrange(logits, ‘B T H V −> B T (H V)’)
logits = reduce(logits, ‘B T (H V) −> B T V’, ‘sum’, H=self.n_hyper)
x_embedding_leh = x_embedding
```

In step 305, the loss function is calculated.

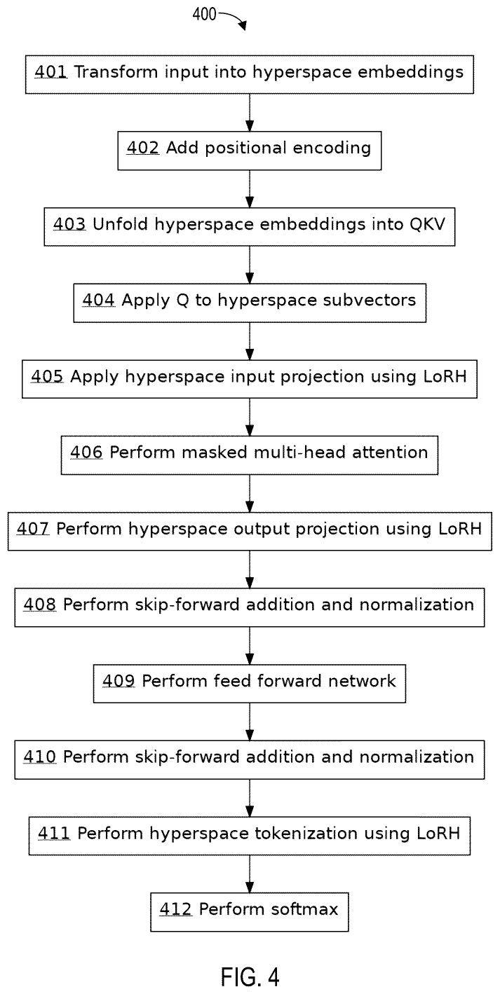

FIG. 4 shows a flowchart of a hyperformer method 400 corresponding to layers 106 through 130 of the attention-based hyperformer 102 in the machine-learning system 100 (FIG. 1) in accordance with some embodiments.

In step 401, the input sequence is converted into hyperspace embeddings. In step 402, positional encodings are added to the hyperspace embeddings. In step 403, the hyperspace embeddings are unfolded into traditional QKV representations. In step 404, a respective Q vector is applied to the subvectors of each hyperspace embedding. In step 405, the LoRH function is applied to the hyperspace embeddings. In step 406, a traditional masked multi-head attention is performed. In step 407, the LoRH function is applied to the hyperspace embeddings. In step 408, a first skip-forward addition and normalization are performed. In step 409, a feed forward network is performed. In step 410, a second skip-forward addition and normalization are performed. In step 411, a hyperspace tokenization using LoRH is performed. In step 412, a softmax function is applied to select the most likely output token.

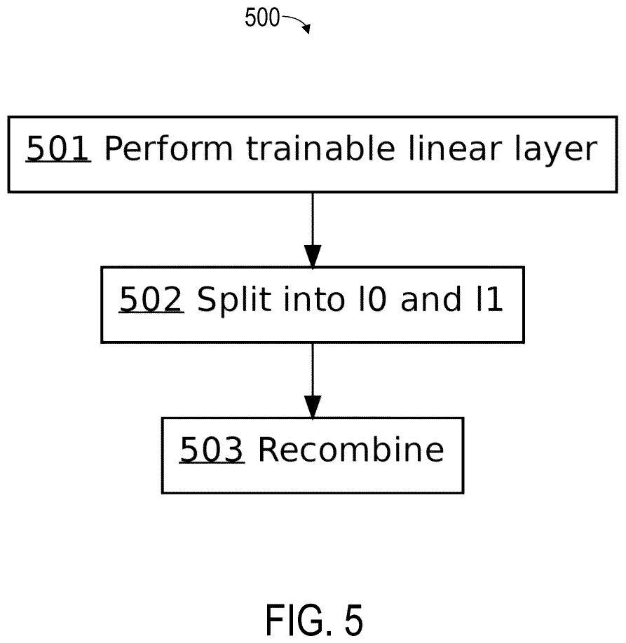

FIG. 5 shows a flowchart of a LoRH function (e.g., as used in the hyperformer method 400, FIG. 4) in accordance with some embodiments.

In step 501, a linear layer is applied (e.g., using c_attn, c_proj, or lm_head).

In step 502, the output from the linear layer is split into 10 and 11 for x, y, and logits.

$$x\_ 10 = rearrange ( … )$$

$$x\_ 11 = rearrange ( … )$$

For the hyperspace input projection (e.g., of step 116, FIG. 1), the split may be performed as follows:

```
x_10 = rearrange(x[..., : kqv * self.n_hyper * self.n_att_lora],
          ‘B T (kqv Hn_att_lora) −> B T kqv Hn_att_lora’,
          n_att_lorh=self.n_att_lorh,
          kqv=kqv,)
x_11 = rearrange(self.att_query_as_vector[..., kqv * self.n_hyper * self.n_att_lorh : −C
            if self.att_query_as_vector else self.att_query_as_vector.shape[−1] ],
          ‘B T (kqv n_att_lora C) −> B T kqv n_att_lora C’,
          n_att_lorh=self.n_att_lorh,
          kqv=kqv,)
```

For the hyperspace output projection (e.g., of step 118, FIG. 1), the split may be performed as follows:

```
y_10 = rearrange(y[..., : self.n_hyper * self.n_att_lora],
          ‘B T (Hn_att_lora) −> B T H n_att_lorh’,
          n_att_lorh=self.n_att_lorh,)
y_11 = rearrange(y[..., self.n_hyper * self.n_att_lorh :],
          ‘B T (n_att_lora C) −> B Tn_att_lora C’,
          n_att_lorh=self.n_att_lorh,)
```

For the hyperspace tokenization (e.g., the hyperspace tokenization 128, FIG. 1), the split may be performed as follows:

```
logits_10 = rearrange(logits[..., : self.n_hyper * self.n_out_vocab_lorh],
          ‘B T (Hn_out_vocab_lorh) −> B T H n_out_vocab_lorh’,
          n_out_vocab_lorh=self.n_out_vocab_lorh,)
logits_11 = rearrange(logits[..., self.n_hyper * self.n_out_vocab_lorh :],
          ‘B T (n_out_vocab_lorh V) −> B Tn_out_vocab_lorh V’,
          n_out_vocab_lorh=self.n_out_vocab_lorh,)
```

In step 503, the two factors are recombined with a matrix multiplication. For example:

$$x = x\_ 10 @ x\_ 11$$

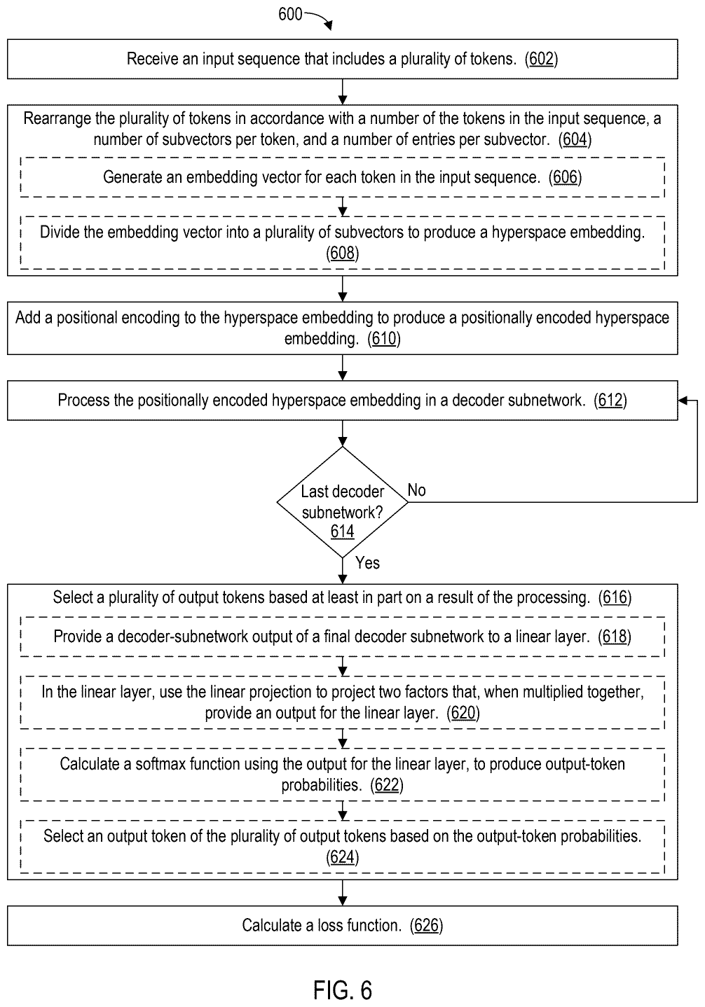

FIG. 6 shows a flowchart of a machine-learning method 600 performed by a hyperformer in accordance with some embodiments. In step 602 of the method 600, an input sequence (e.g., input sequence 104, FIG. 1) is received that includes a plurality of tokens. In step 604, the plurality of tokens is rearranged in accordance with a number of the tokens in the input sequence, a number of subvectors per token, and a number of entries per subvector. Rearranging the plurality of tokens includes generating an embedding vector for each token in the input sequence, in step 606, and dividing the embedding vector into a plurality of subvectors to produce a hyperspace embedding, in step 608. The hyperspace embedding includes the plurality of subvectors. Generating an embedding vector for each token in the input sequence may be performed in the embedding layer 106 (FIG. 1). Dividing the embedding vector into a plurality of subvectors to produce a hyperspace embedding may be performed in the hyperspace embeddings layer 108 (FIG. 1). In step 610, a positional encoding (e.g., positional encoding 109, FIG. 1) is added to the hyperspace embedding to produce a positionally encoded hyperspace embedding. This addition may be performed in the addition layer 110 (FIG. 1).

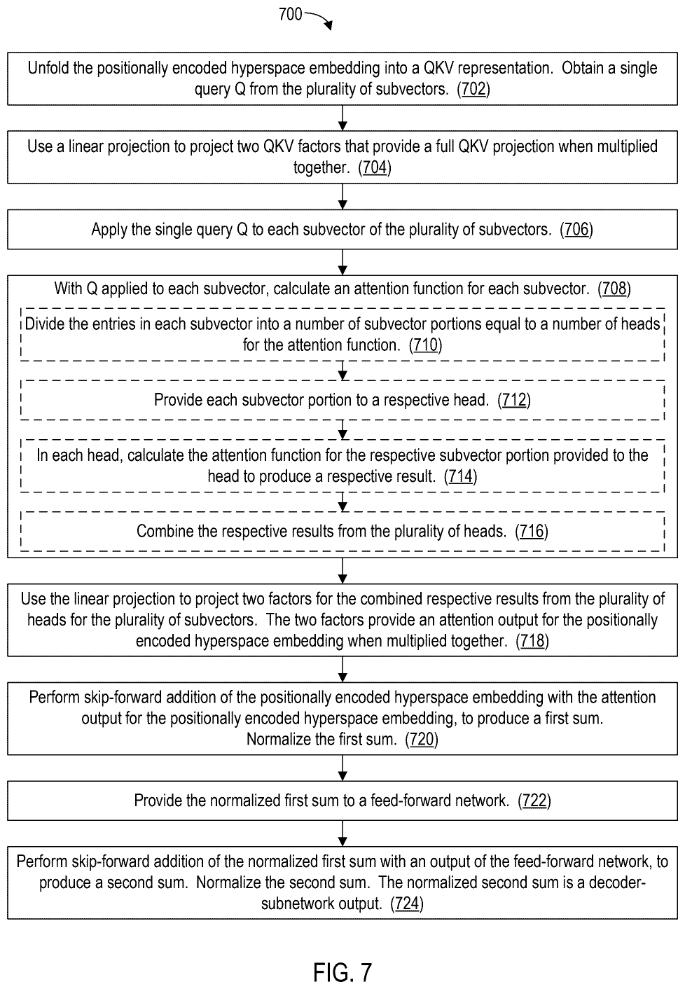

In step 612, the positionally encoded hyperspace embedding is processed in a decoder subnetwork (e.g., a decoder subnetwork 111, FIG. 1) in accordance with a method 700, as shown in FIG. 7 in accordance with some embodiments. In step 702 of the method 700, the positionally encoded hyperspace embedding is unfolded into a QKV representation (e.g., per step 201, FIG. 2). This unfolding includes obtaining a single query Q from the plurality of subvectors. In step 704, a linear projection (e.g., per step 116, FIG. 1; step 203, FIG. 2) is used to project two QKV factors that provide a full QKV projection when multiplied together. The full QKV projection is used in calculating the attention function.

In step 706, the single query Q is applied to each subvector of the plurality of subvectors (e.g., per step 114, FIG. 1; step 202, FIG. 2). With the single query Q applied to each subvector, an attention function is calculated for each subvector in step 708 (e.g., per step 204, FIG. 2). In some embodiments, the attention function is a multi-head attention function with a plurality of heads (e.g., the multi-head attention function for the multi-head attention layer 112, FIG. 1; the masked multi-head attention block 200, FIG. 2). To calculate the multi-head attention function, in step 710 the entries in each subvector are divided into a number of subvector portions equal to a number of heads for the attention function. In step 712, each subvector portion is provided to a respective head of the plurality of heads. In each head of the plurality of heads, the attention function for the respective subvector portion provided to the head is calculated in step 714, to produce a respective result. The respective results from the plurality of heads are combined in step 716.

After calculating the attention function and combining the respective results, the linear projection is used in step 718 to project two factors for the combined respective results from the plurality of heads for the plurality of subvectors (e.g., per step 118, FIG. 1; step 206, FIG. 2). The two factors are multiplied together to provide an attention output for the positionally encoded hyperspace embedding (e.g., per step 207, FIG. 2).

In step 720, skip-forward addition of the positionally encoded hyperspace embedding with the attention output for the positionally encoded hyperspace embedding (e.g., the first skip-forward addition 120, FIG. 1) is performed, to produce a first sum. The first sum is normalized. The normalized first sun is provided in step 722 to a feed-forward network (e.g., feed-forward network 122, FIG. 1). Skip-forward addition of the normalized first sum with an output of the feed-forward network (e.g., the second skip-forward addition 124, FIG. 1) is performed in step 724, to produce a second sum. The second sum is normalized. The normalized second sum is a decoder-subnetwork output.

Returning to FIG. 6, in some embodiments the decoder subnetwork used to process the positionally encoded hyperspace in a first iteration of step 612 (e.g., in a first iteration of the method 700, FIG. 7) is a first decoder subnetwork in a series of decoder subnetworks (e.g., a first decoder subnetwork 111 of the N decoder subnetworks 111, FIG. 1). The method 600 further includes repeating the processing of step 612 (e.g., repeating the method 700) in each decoder subnetwork after the first decoder subnetwork in the series (e.g., in each of the N decoder subnetworks 111 after the first decoder subnetwork 111, FIG. 1), using a respective input of each decoder subnetwork in place of the positionally encoded hyperspace embedding used in the first decoder subnetwork. The respective input of each decoder subnetwork after the first decoder subnetwork in the series is the decoder-subnetwork output of the previous decoder subnetwork in the series. For example, after an iteration of the processing of step 612 is performed by a given decoder subnetwork in the series, it is determined in step 614 whether the given decoder subnetwork is the final decoder subnetwork in the series. If it is not (614—No), the method 600 returns to step 612 to perform another iteration of the processing of step 612 using the next decoder subnetwork in the series (i.e., the decoder subnetwork immediately following the given decoder subnetwork in the series). The next decoder subnetwork uses the decoder-subnetwork output of the given decoder subnetwork as its input, whereas the first decoder subnetwork in the series used the hyperspace embedding as its input. The next decoder subnetwork thus performs this processing on the decoder-subnetwork output of the given decoder subnetwork.

If the given decoder subnetwork is the final decoder subnetwork in the series (614—Yes), then no more iterations of step 612 are performed. The method 700 proceeds to step 616, in which a plurality of output tokens (e.g., in an output sequence 134, FIG. 1) is selected based at least in part on a result of the processing. In some embodiments, to select the plurality of output tokens, the decoder-subnetwork output of the final decoder subnetwork is provided to a linear layer (e.g., final linear output linear layer 126, FIG. 1; final linear block 300, FIG. 3) in step 618. In the linear layer, the linear projection is used in step 620 to project two factors that, when multiplied together, provide an output for the linear layer (e.g., per the LoRH function; per step 304, FIG. 3). In step 622, a softmax function (e.g., softmax function 130, FIG. 1) is calculated using the output for the linear layer, to produce output-token probabilities (e.g., output probabilities 132, FIG. 1). An output token of the plurality of output tokens is selected in step 624 based on the output-token probabilities.

In step 626, a loss function is calculated. In some embodiments, the loss function is calculated based at least in part on a difference between the selected output token and an expected output token. In some other embodiments, the loss function is calculated based at least in part on a difference between the output for the linear layer and an expected output for the linear layer (e.g., per step 305, FIG. 3). Back-propagation through the hyperformer is performed in accordance with the loss function, to train the hyperformer.

To evaluate hyperformer performance, a hyperformer was used to predict chess-notation tokens. The results of training the hyperformer on these chess-notation tokens were compared to the results of training a conventional transformer on these chess-notation tokens.

The conventional transformer model has 6 blocks, 3 attention heads and 246 embedding elements:

gpt-1998-16-9.37M: dict (n_layer=6, n_head=3, n_embd=246)

The conventional transformer model uses 9.33M parameters and has an evaluation loss of 2.07 after 12,000 iterations. Training results for the conventional transformer model were as follows:
*** Training on regular model gpt-1998-16-9.37M ***
number of parameters: 9.33M
running on device cuda
iter_dt 0.00 ms; iter 0: train loss 9.25532, eval loss 8.86062
iter_dt 26.50 ms; iter 499: train loss 3.18170, eval loss 3.18966
iter_dt 26.46 ms; iter 999: train loss 2.78161, eval loss 2.85395
iter_dt 28.01 ms; iter 1499: train loss 2.64427, eval loss 2.68704
iter_dt 27.48 ms; iter 1999: train loss 2.47910, eval loss 2.57517
iter_dt 27.57 ms; iter 2499: train loss 2.42265, eval loss 2.48823
iter_dt 27.52 ms; iter 2999: train loss 2.23633, eval loss 2.42764
iter_dt 27.40 ms; iter 3499: train loss 2.37670, eval loss 2.37927
iter_dt 22.98 ms; iter 3999: train loss 2.28821, eval loss 2.33581
iter_dt 28.08 ms; iter 4499: train loss 2.22052, eval loss 2.30276
iter_dt 27.92 ms; iter 4999: train loss 2.14421, eval loss 2.27196
iter_dt 28.02 ms; iter 5499: train loss 2.12592, eval loss 2.23829
iter_dt 27.88 ms; iter 5999: train loss 2.12750, eval loss 2.22088
iter_dt 26.60 ms; iter 6499: train loss 2.07536, eval loss 2.19900
iter_dt 26.78 ms; iter 6999: train loss 2.05119, eval loss 2.18489
iter_dt 26.49 ms; iter 7499: train loss 1.98321, eval loss 2.16730
iter_dt 26.15 ms; iter 7999: train loss 1.98407, eval loss 2.15162
iter_dt 28.23 ms; iter 8499: train loss 1.96504, eval loss 2.14276
iter_dt 28.21 ms; iter 8999: train loss 1.90253, eval loss 2.12761
iter_dt 28.20 ms; iter 9499: train loss 1.89058, eval loss 2.11489
iter_dt 28.60 ms; iter 9999: train loss 1.79500, eval loss 2.10792
iter_dt 28.14 ms; iter 10499: train loss 1.89222, eval loss 2.09428
iter_dt 28.58 ms; iter 10999: train loss 1.92044, eval loss 2.09055
iter_dt 28.09 ms; iter 11499: train loss 1.85483, eval loss 2.08143
iter_dt 28.32 ms; iter 11999: train loss 1.88544, eval loss 2.07395

The hyperformer model has 6 blocks, 3 attention heads, 6×48 hyperspace and no hyperspace tokenization:

‘gpt-16-hyper6-hidden1’: dict (n_layer=6,n_head=3,n_embd=48,n_hyper=6)

The hyperformer model uses 6.37M parameters and has an evaluation loss of 2.07 after 12000 iterations. Training results for the hyperformer model were as follows:
** raining on hyperspace model gpt-16-hyper6-hidden1 with attention mode normal*** ***layernorm vanilla***
number of parameters: 6.37M
running on device cuda
iter_dt 0.00 ms; iter 0: train loss 9.28668, eval loss 8.87906
iter_dt 28.70 ms; iter 499: train loss 3.01294, eval loss 3.14762
iter_dt 28.12 ms; iter 999: train loss 2.75125, eval loss 2.78779
iter_dt 26.92 ms; iter 1499: train loss 2.52508, eval loss 2.60984
iter_dt 27.00 ms; iter 1999: train loss 2.33595, eval loss 2.49929
iter_dt 28.81 ms; iter 2499: train loss 2.34066, eval loss 2.42928
iter_dt 28.81 ms; iter 2999: train loss 2.29107, eval loss 2.37045
iter_dt 28.68 ms; iter 3499: train loss 2.27840, eval loss 2.32255
iter_dt 28.54 ms; iter 3999: train loss 2.21331, eval loss 2.29085
iter_dt 28.91 ms; iter 4499: train loss 2.08869, eval loss 2.26008
iter_dt 28.71 ms; iter 4999: train loss 2.02819, eval loss 2.23798
iter_dt 28.34 ms; iter 5499: train loss 2.08408, eval loss 2.21747
iter_dt 27.22 ms; iter 5999: train loss 1.95376, eval loss 2.19457
iter_dt 26.94 ms; iter 6499: train loss 2.04355, eval loss 2.17761
iter_dt 26.90 ms; iter 6999: train loss 2.02667, eval loss 2.16214
iter_dt 22.50 ms; iter 7499: train loss 2.07406, eval loss 2.15406
iter_dt 28.54 ms; iter 7999: train loss 1.97724, eval loss 2.13929
iter_dt 27.04 ms; iter 8499: train loss 2.00414, eval loss 2.12981
iter_dt 27.03 ms; iter 8999: train loss 1.92918, eval loss 2.11791
iter_dt 27.03 ms; iter 9499: train loss 1.96861, eval loss 2.10873
iter_dt 22.75 ms; iter 9999: train loss 1.85256, eval loss 2.10034
iter_dt 27.19 ms; iter 10499: train loss 1.77924, eval loss 2.08864
iter_dt 28.41 ms; iter 10999: train loss 1.95183, eval loss 2.08355
iter_dt 28.45 ms; iter 11499: train loss 1.85299, eval loss 2.07684
iter_dt 28.81 ms; iter 11999: train loss 1.90227, eval loss 2.06927

The hyperformer therefore achieved a 30% reduction in parameters compared to the conventional transformer while still achieving the same evaluation loss after the same training time.

A hyperformer as disclosed herein may be implemented using one or more conventional general purpose or specialized digital computers, computing devices, machines, or microprocessors, including one or more processors, memory and/or computer readable storage media programmed according to the teachings of the present disclosure. Appropriate software coding can readily be prepared by skilled programmers based on the teachings of the present disclosure, as will be apparent to those skilled in the art.

In some embodiments, a computer program product includes a non-transitory storage medium or computer readable medium (media) having instructions stored thereon/in which can be used to program a computer to perform any of the hyperformer processes. The storage medium can include, but is not limited to, any type of disk including floppy disks, optical discs, DVD, CD-ROMs, microdrive, and magneto-optical disks, ROMs, RAMs, EPROMS, EEPROMs, DRAMs, VRAMs, flash memory devices, magnetic or optical cards, nanosystems (including molecular memory ICs), or any type of media or device suitable for storing instructions and/or data.

FIG. 8 is a block diagram of a computer system 800 that implements a hyperformer, in accordance with some embodiments. In some embodiments, the computer system 800 is used to train a hyperformer. The computer system 800 typically includes one or more processors 802 (e.g., CPUs 804 and/or GPUs 806), one or more network interfaces 807 (wired and/or wireless), memory 810, and one or more communication buses 808 interconnecting these components.

Memory 810 includes volatile and/or non-volatile memory. Memory 810 (e.g., the non-volatile memory within memory 810) includes a non-transitory computer-readable storage medium. Memory 810 optionally includes one or more storage devices remotely located from the one or more processors 802 and/or a non-transitory computer-readable storage medium that is removably inserted into the computer system 800. In some embodiments, memory 810 (e.g., the non-transitory computer-readable storage medium of memory 810) stores a hyperformer module 812 for implementing a hyperformer (e.g., hyperformer 102, FIG. 1). The hyperformer module 812 includes an input embedding module 814 (e.g., for implementing the embedding layer 106, FIG. 1), a subnetwork module 816 (e.g., for implementing decoder subnetworks 111, FIG. 1), a linear-layer module 818 (e.g., for implementing the final linear output layer 126, FIG. 1), and a softmax module 820 (e.g., for implementing the softmax function 130, FIG. 1). The subnetwork module 816 may include instruction for implementing the masked multi-head attention block 200 (FIG. 2). The linear-layer module 818 may include instructions for implementing the final linear block 300 (FIG. 3). Memory 810 also stores a training module 822 for implementing a back-propagation training process for the hyperformer module 812. The memory 810 (e.g., the modules 812-822 collectively, or a portion thereof) may include instructions for performing the methods 400 (FIG. 4), 600 (FIG. 6) and/or 700 (FIG. 7) or a portion thereof.

Each of the modules stored in memory 810 corresponds to a set of instructions for performing one or more functions described herein. The set of instructions is configured for execution by the one or more processors 802. Separate modules need not be implemented as separate software programs. The modules and various subsets of the modules may be combined or otherwise re-arranged. In some embodiments, memory 810 stores a subset or superset of the modules and/or data structures identified above.

FIG. 8 is intended more as a functional description of the various features that may be present in a computer system than as a structural schematic. In practice, modules shown separately could be combined and some modules could be separated. For example, modules shown in FIG. 8 could be implemented on a single server or on a plurality of servers. The actual number of servers used to implement the computer system 800, and how modules are allocated among them, will vary from one implementation to another.

The foregoing description has been provided for the purposes of illustration and description. It is not intended to be exhaustive or to limit the scope of the claims to the precise forms disclosed. Many modifications and variations will be apparent to the practitioner skilled in the art. The embodiments were chosen and described in order to best explain the principles underlying the claims and their practical applications, thereby enabling others skilled in the art to understand and use the embodiments with various modifications that are suited to the particular use contemplated. It is intended that the scope of the disclosure be defined by the following claims and their equivalence.

What is claimed is:

1. A machine-learning method, comprising:
receiving an input sequence comprising a plurality of tokens;
rearranging the plurality of tokens in accordance with a number of the tokens in the input sequence, a number of subvectors per token, and a number of entries per subvector, comprising:
generating an embedding vector for each token in the input sequence, and
dividing the embedding vector into a plurality of subvectors to produce a hyperspace embedding;
adding a positional encoding to the hyperspace embedding to produce a positionally encoded hyperspace embedding;
processing the positionally encoded hyperspace embedding in a decoder subnetwork, the processing comprising:
unfolding the positionally encoded hyperspace embedding into a query, key, and value (QKV) representation, comprising obtaining a single query Q from the plurality of subvectors;
applying the single query Q to each subvector of the plurality of subvectors; and
with the single query Q applied to each subvector, calculating an attention function for each subvector; and
selecting a plurality of output tokens based at least in part on a result of the processing.

2. The method of claim 1, wherein:
the attention function is a multi-head attention function comprising a plurality of heads; and
calculating the attention function comprises:
dividing the entries in each subvector into a number of subvector portions equal to a number of heads in the plurality of heads;
providing each subvector portion to a respective head of the plurality of heads;
in each head of the plurality of heads, calculating the attention function for the respective subvector portion provided to the head to produce a respective result; and
combining the respective results from the plurality of heads.

3. The method of claim 2, wherein the processing further comprises:
before calculating the attention function, using a linear projection to project two QKV factors that provide a full QKV projection when multiplied together, wherein the full QKV projection is used in calculating the attention function; and
after calculating the attention function and combining the respective results, using the linear projection to project two factors for the combined respective results from the plurality of heads for the plurality of subvectors, wherein the two factors provide an attention output for the positionally encoded hyperspace embedding when multiplied together.

4. The method of claim 3, wherein the processing further comprises:
performing skip-forward addition of the positionally encoded hyperspace embedding with the attention output for the positionally encoded hyperspace embedding, to produce a first sum; and
normalizing the first sum.

5. The method of claim 4, wherein the processing further comprises:
providing the normalized first sum to a feed-forward network;
performing skip-forward addition of the normalized first sum with an output of the feed-forward network, to produce a second sum; and
normalizing the second sum;
wherein the normalized second sum is a decoder-subnetwork output.

6. The method of claim 5, wherein:
the decoder subnetwork is a first decoder subnetwork in a series of decoder subnetworks;
the method further comprises repeating the processing in each decoder subnetwork after the first decoder subnetwork in the series, using a respective input of each decoder subnetwork in place of the positionally encoded hyperspace embedding used in the first decoder subnetwork;
and the respective input of each decoder subnetwork after the first decoder subnetwork in the series is the decoder-subnetwork output of the previous decoder subnetwork in the series.

7. The method of claim 6, wherein the selecting comprises:
providing the decoder-subnetwork output of a final decoder subnetwork in the series of decoder subnetworks to a linear layer; and
in the linear layer, using the linear projection to project two factors that, when multiplied together, provide an output for the linear layer.

8. The method of claim 7, wherein the selecting further comprises:
calculating a softmax function using the output for the linear layer, to produce output-token probabilities; and
selecting an output token of the plurality of output tokens based on the output-token probabilities.

9. The method of claim 8, further comprising calculating a loss function based at least in part on a difference between the selected output token and an expected output token.

10. The method of claim 7, further comprising calculating a loss function based at least in part on a difference between the output for the linear layer and an expected output for the linear layer.

11. A computer system, comprising:
one or more processors; and
memory storing one or more programs configured for execution by the one or more processors, the one or more programs comprising instructions for:
rearranging a plurality of tokens in an input sequence in accordance with a number of the tokens in the input sequence, a number of subvectors per token, and a number of entries per subvector, comprising:
generating an embedding vector for each token in the input sequence, and
divided the embedding vector into a plurality of subvectors to produce a hyperspace embedding;
adding a positional encoding to the hyperspace embedding to produce a positionally encoded hyperspace embedding;
processing the positionally encoded hyperspace embedding in a decoder subnetwork, the processing comprising:
unfolding the positionally encoded hyperspace embedding into a query, key, and value (QKV) representation, comprising obtaining a single query Q from the plurality of subvectors;
applying the single query Q to each subvector of the plurality of subvectors; and
with the single query Q applied to each subvector, calculating an attention function for each subvector; and
selecting a plurality of output tokens based at least in part on a result of the processing.

12. A non-transitory computer-readable storage medium storing one or more programs for execution by one or more processors, the one or more programs comprising instructions for:
rearranging a plurality of tokens in an input sequence in accordance with a number of the tokens in the input sequence, a number of subvectors per token, and a number of entries per subvector, comprising:
generating an embedding vector for each token in the input sequence, and
divided the embedding vector into a plurality of subvectors to produce a hyperspace embedding;
adding a positional encoding to the hyperspace embedding to produce a positionally encoded hyperspace embedding;
processing the positionally encoded hyperspace embedding in a decoder subnetwork, the processing comprising:
unfolding the positionally encoded hyperspace embedding into a query, key, and value (QKV) representation, comprising obtaining a single query Q from the plurality of subvectors;
applying the single query Q to each subvector of the plurality of subvectors; and
with the single query Q applied to each subvector, calculating an attention function for each subvector; and
selecting a plurality of output tokens based at least in part on a result of the processing.
